(19) United States
(12) Patent Application Publication
(10) Pub. No.: US 2026/0170257 A1
(43) Pub. Date: Jun. 18, 2026

(54) TEXT PROCESSING METHOD AND APPARATUS, COMPUTER DEVICE, STORAGE MEDIUM, AND PROGRAM PRODUCT

(71) Applicant: Tencent Technology (Shenzhen) Company Limited, Shenzhen (CN)

(72) Inventors: Wei LIU, Shenzhen (CN); Jie JIANG, Shenzhen (CN); Zongwei LI, Shenzhen (CN); Yeting HE, Shenzhen (CN); Sirui GAO, Shenzhen (CN); Zhipeng YANG, Shenzhen (CN); Yao DING, Shenzhen (CN); Guinan SU, Shenzhen (CN); Chunchao GUO, Shenzhen (CN)

(73) Assignee: Tencent Technology (Shenzhen) Company Limited, Shenzhen (CN)

(21) Appl. No.: 19/535,904

(22) Filed: Feb. 10, 2026

Related U.S. Application Data
(63) Continuation of application No. PCT/CN2024/115952, filed on Aug. 30, 2024.

(30) Foreign Application Priority Data
Nov. 17, 2023 (CN) 202311536806.8

(51) Int. Cl. G06F 40/30; G06F 40/126; G06N 3/045; G06N 3/08

(52) U.S. Cl. CPC G06F 40/30; G06F 40/126; G06N 3/045; G06N 3/08

(57) ABSTRACT

A text processing method includes: obtaining a to-be-processed source text, the source text including a plurality of tokens (S501); determining, according to a relative distance between paired tokens in the source text, a relative positional encoding corresponding to the relative distance between the paired tokens, to obtain positional encoding information including the relative positional encoding (S502); obtaining a distance threshold, and determining, from the positional encoding information, a first relative positional encoding corresponding to a relative distance that exceeds the distance threshold; invoking a text processing model, and mapping the first relative positional encoding in the positional encoding information into a positional encoding range of the text processing model, to obtain mapped positional encoding information (S503); and invoking the text processing model, and performing semantic understanding on the source text according to the mapped positional encoding information, to generate a semantically associated text of the source text (S504).

### RELATED APPLICATION

This application is a continuation of and claims the benefit of priority to PCT Application No. PCT/CN2024/115952, filed Aug. 30, 2024, and entitled TEXT PROCESSING METHOD AND APPARATUS, AND COMPUTER DEVICE, STORAGE MEDIUM AND PROGRAM PRODUCT, which is based on and claims priority to Chinese Patent Application No. 202311536806.8, filed on Nov. 17, 2023 and entitled “TEXT PROCESSING METHOD AND APPARATUS, COMPUTER DEVICE, STORAGE MEDIUM, AND PROGRAM PRODUCT.” The above applications are incorporated herein by reference in their entireties.

### FIELD OF THE TECHNOLOGY

The present disclosure relates to the field of computer technologies, in particular, to the technical field of artificial intelligence, and specifically, to a text processing method and apparatus, a computer device, a computer-readable storage medium, and a computer program product.

### BACKGROUND OF THE DISCLOSURE

A Transformer model structure (a language model structure) based on an Attention mechanism has been widely applied to the field of natural language processing of artificial intelligence, and has become a popular language model structure currently. However, a pure Attention module cannot capture an order of tokens in input text, which makes the role of positional encoding in a Transformer model especially important. Positional encoding is a position representation method, and may represent positions of the tokens in the input text through encoding.

Currently, when a model performs text processing by a conventional positional encoding method, for some texts with seen text lengths (the seen text length refers to a text length that appears in a training process of the model), which are usually shorter, the model can achieve a relatively good text processing effect. However, for some texts with unseen text lengths (the unseen text length refers to a text length that does not appear at a training stage of the model and exceeds the text length that appears in the training process), which are usually longer, the text processing effect tends to be poor. That is, generalization performance of the conventional positional encoding method is insufficient. This means that when the model processes an input with an unseen text length that exceeds the text length in the training process, an extrapolation capability may be insufficient, which results in a poor inference effect of the model.

### SUMMARY

Embodiments of the present disclosure provide a text processing method and apparatus, a computer device, a storage medium, and a program product.

In an aspect, the embodiments of the present disclosure provide a text processing method, which is performed by a computer device and includes:
obtaining a to-be-processed source text, the source text including a plurality of tokens;
determining, according to a relative distance between paired tokens in the source text, a relative positional encoding corresponding to the relative distance between the paired tokens, to obtain positional encoding information including the relative positional encoding;
obtaining a distance threshold, and determining, from the positional encoding information, a first relative positional encoding corresponding to a relative distance that exceeds the distance threshold;
invoking a text processing model, and mapping the first relative positional encoding in the positional encoding information into a positional encoding range of the text processing model, to obtain mapped positional encoding information; and
invoking the text processing model, and performing semantic understanding on the source text according to the mapped positional encoding information, to generate a semantically associated text of the source text.

In another aspect, the embodiments of the present disclosure provide a text processing apparatus, which includes:
an obtaining unit, configured to obtain a to-be-processed source text, the source text including a plurality of tokens,
the obtaining unit being further configured to determine, according to a relative distance between paired tokens in the source text, a relative positional encoding corresponding to the relative distance between the paired tokens, to obtain positional encoding information including the relative positional encoding; and
a processing unit, configured to obtain a distance threshold, and determine, from the positional encoding information, a first relative positional encoding corresponding to a relative distance that exceeds the distance threshold; and invoke a text processing model, and map the first relative positional encoding in the positional encoding information into a positional encoding range of the text processing model, to obtain mapped positional encoding information,
the processing unit being further configured to invoke the text processing model, and perform semantic understanding on the source text according to the mapped positional encoding information, to generate a semantically associated text of the source text.

In still another aspect, the embodiments of the present disclosure provide a computer device. The computer device includes:
a processor, configured to implement a computer program;
a computer-readable storage medium, the computer-readable storage medium having the computer program stored therein, and the computer program being loaded by the processor to perform the foregoing text processing method.

In still another aspect, the embodiments of the present disclosure provide a computer-readable storage medium. The computer-readable storage medium has a computer program stored therein, and the computer program, when read and executed by a processor of a computer device, causes the computer device to perform the foregoing text processing method.

In still another aspect, the embodiments of the present disclosure provide a computer program product. The computer program product includes a computer program, and the computer program is stored in a computer-readable storage medium. A processor of a computer device reads the computer program from the computer-readable storage medium and executes the computer program, to cause the computer device to perform the foregoing text processing method.

Details of one or more embodiments of the present disclosure are provided in the accompanying drawings and descriptions below. Other features, objectives, and advantages of the present disclosure become apparent from the specification, the drawings, and the claims.

### BRIEF DESCRIPTION OF THE DRAWINGS

To illustrate technical solutions in embodiments of the present disclosure or in the conventional technology more clearly, the accompanying drawings required for the description of the embodiments or the conventional technology will be briefly introduced below. Apparently, the accompanying drawings in the following description are only the embodiments of the present disclosure, and a person of ordinary skill in the art may further derive other drawings from these drawings without making creative efforts.

FIG. 1 is an example schematic diagram of calculating an attention weight according to an embodiment of the present disclosure.

FIG. 2 is an example schematic diagram of a long-text understanding scenario according to an embodiment of the present disclosure.

FIG. 3 is an example schematic diagram of a long-text generation scenario according to an embodiment of the present disclosure.

FIG. 4 is an example schematic diagram of a multi-turn dialog scenario according to an embodiment of the present disclosure.

FIG. 5 is an example schematic flowchart of a text processing method according to an embodiment of the present disclosure.

FIG. 6 is an example schematic structural diagram of a text processing model according to an embodiment of the present disclosure.

FIG. 7 is an example schematic flowchart of recursive semantic understanding according to an embodiment of the present disclosure.

FIG. 8 is an example schematic flowchart of another text processing method according to an embodiment of the present disclosure.

FIG. 9 is an example schematic diagram of a comparison of relative positional encoding methods according to an embodiment of the present disclosure.

FIG. 10 is an example schematic diagram of a role of relative positional encoding in semantic understanding according to an embodiment of the present disclosure.

FIG. 11 is an example schematic structural diagram of a text processing apparatus according to an embodiment of the present disclosure.

FIG. 12 is an example schematic structural diagram of a computer device according to an embodiment of the present disclosure.

### DESCRIPTION OF EMBODIMENTS

The technical solutions in embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments in the present disclosure without making creative efforts still fall within the scope of protection of the present disclosure.

For ease of understanding of the technical solutions provided in the embodiments of the present disclosure, some key terms involved in the embodiments of the present disclosure are explained below first.

Text processing may alternatively be understood as text generation, and in the embodiments of the present disclosure, refers to a process of invoking a text processing model, and performing semantic understanding on a text, to generate a semantically associated text based on understood semantics. A text processing process in the embodiments of the present disclosure may generally include: first, the text processing model may be invoked, word segmentation is performed on a text, to obtain a plurality of tokens included in the text. The token refers to a language character (a language word refers to a word of a natural language) or a language word (a language word refers to a word of the natural language) in the text. Second, the text processing model may be invoked to determine an attention weight between paired tokens in the text based on a similarity between the paired tokens in the text through an attention mechanism; and the text processing model may be invoked, and weighted summation is performed on a corresponding token in the text according to the attention weight between the paired tokens in the text, to obtain an attention feature of each token in the text. The attention feature of each token in the text may be understood as a semantic feature of the token, and may be configured for representing semantics of the token. Then, the text processing model may be invoked to generate the semantically associated text based on the semantic feature of each token in the text. The text processing model may be a large language model in the field of natural language processing of artificial intelligence technologies. The large language model refers to a deep learning model trained by using a large amount of text data, and may generate a natural language text or understand meanings of the natural language text. For example, the text processing model may be a large prediction model based on a Transformer model structure.

It can be learned that in a text processing process, an attention mechanism plays an important role. The attention mechanism is a network structure for sequence learning, and is usually configured for modeling a language sequence during text processing in recent years, and is configured for tasks such as text understanding and text generation. For a common implementation of the attention mechanism, refer to the following descriptions:

It is assumed that a text X is a text with a text length of N. The text length refers to a quantity of tokens included in the text. That is, the text X includes N tokens, and the text X is a sequence input of tokens (namely, language characters or language words) with the text length of N Linear mapping may be performed on the text X to obtain a query matrix (Q matrix), a key matrix (K matrix), and a value matrix (V matrix). An attention weight matrix may be expressed as formula 1 below:

$$AttSim ( Q , K ) = softmax ( \frac{Q ( X ) {K ( X )}^{T}}{d} ) ∈ {R}^{N * N} \qquad formula 1$$

where AttSim(Q, K) denotes the attention weight matrix; Q and K denote two projection matrix operations, Q denotes the Q matrix, and K denotes the K matrix; and d denotes a scaling factor, configured for maintaining stability of model training of the text processing model. The attention weight matrix may be configured for performing weighted summation on the V matrix, to output an attention feature Z (namely, a semantic feature Z). For details, refer to formula 2 below:

$$Z ( X ) = A t t s i m ( Q ( X ) , K ( X ) ) * {V ( X )}^{T} \qquad formula 2$$

where V denotes a projection matrix operation, and V denotes the V matrix.

Particularly, in the text processing process, characters or words of a natural language are generated character by character from left to right. Therefore, in a process of calculating an attention feature, for each token, only a similarity between the token and a preceding token needs to be calculated, and weighted summation is performed. A preceding token of a current token may include the current token and tokens that are in the text and that are arranged before the current token. Generally, the process may be introduced through an attention mask. In addition, the attention mechanism cannot capture an order of tokens in the text, and the order of the tokens in the text helps understand context semantics of the tokens. Therefore, a relative positional encoding between paired tokens needs to be introduced to represent a relative distance between the paired tokens. The following separately describes the attention mask and the relative positional encoding in the attention mechanism:

### 1. Attention Mask:

For the text with the text length of N, the attention mask of the text may be set to Mask∈R^{N*N}, and a matrix form is N*N, which is aligned with a matrix form of the attention weight matrix in formula 1 above. Values of elements of the attention mask are defined as formula 3 below:

$${mask}_{i , k} = \{ \begin{matrix}0 , i \geq j \\ - ∞ , i < j\end{matrix} \qquad formula 3$$

where i denotes the i^{th} token in the text, and the i^{th} token is arranged at the i^{th} position in the text; j denotes the j^{th} token in the text, and the j^{th} token is arranged at the j^{th} position in the text; and mask_{i,j} denotes a value of an element that is in the attention mask and that is between the i^{th} token and the j^{th} token in the attention mask. The attention mask acts on the attention weight matrix, and may implement a function of “calculating, for each token, only a similarity between the token and a preceding token of the token and performing weighted summation”. Therefore, the formula 1 above may be rewritten as formula 4 below:

$$AttSim\_withMask ( Q , K ) = softmax ( \frac{Q {K}^{T}}{d} + Mask ) ∈ {R}^{N * N} \qquad formula 4$$

where AttSim_withMask(Q,K) denotes an attention weight matrix updated based on the attention mask, and Mask denotes the attention mask.

### 2. Relative Positional Encoding:

For a relative positional encoding (using an Attention with Linear Biases (Alibi) relative positional encoding method as an example), a relative position relationship between paired tokens in the text may be mapped to one bias in a form of an attention map (the attention weight matrix), to act on the attention map. An Alibi relative positional encoding represents the relative position relationship between the paired tokens in the text by introducing the bias. An original Alibi relative positional encoding and an action manner of the original Alibi relative positional encoding in the attention weight are expressed as formula 5 below:

$$A t t S i {m}_{a l i b i ( {q}_{i} , K )} = softmax ( \frac{{q}_{i} {K}^{T}}{d} + M a s {k}_{i} + m * [ - ( i - 1 ) , … , - 2 , - 1 , 0 ] ) ∈ {R}^{1 * N} \qquad formula 5$$

where AttSim_{alibi(q}_{ᵢ}_{,K)} denotes an attention weight between the i^{th} token and each preceding token of the i^{th} token; Mask; denotes a value of an element that is in the attention mask and that corresponds to the i^{th} token; m*[−(i−1), . . . , −2, −1,0] denotes a relative positional encoding between the i^{th} token and each preceding token of the i^{th} token, for example, m*[−(i−1)] denotes a relative positional encoding between the i^{th} token and the 1st token; and m is a relative distance coefficient, which is a fixed constant coefficient.

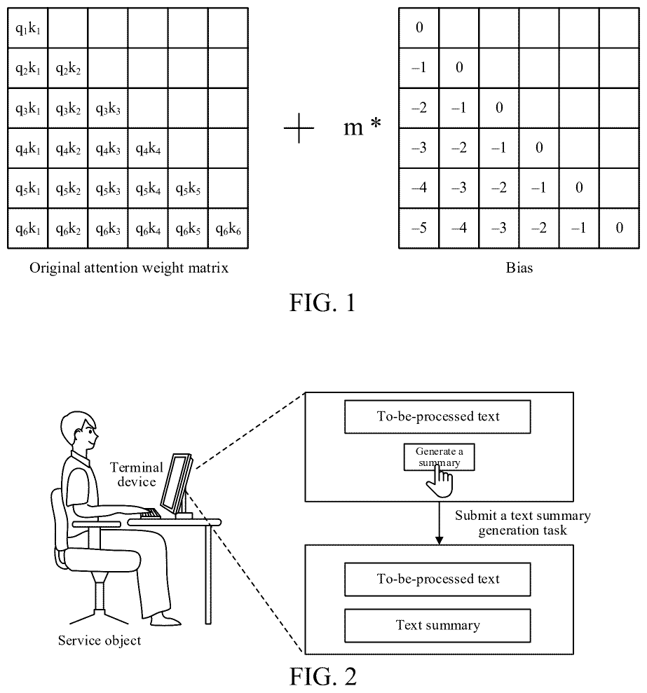

In conclusion, the attention mask and the relative positional encoding may be introduced to the original attention weight, to update the attention weight and implement a function of calculating a similarity between each token in a text and a preceding token of the token. In addition, the order of the tokens in the text is considered in the calculation process of the attention mechanism, to improve a semantic understanding capability of the attention mechanism. A text with a text length of 6 is used as an example. For effects of an attention mask and a relative positional encoding on an original attention weight, refer to FIG. 1. In a left matrix in FIG. 1, q₆k₁ denotes an attention weight between the 6^{th} token and the 1^{st} token in the text, q₄k₃ denotes an attention weight between the 4^{th} token and the 3^{rd} token in the text. By analogy, q₁k₁ denotes an attention weight between the 1^{st} token and the 1^{st} token in the text; In the left matrix in FIG. 1, elements in the matrix are incomplete due to the effect of the attention mask. The attention mask ensures that the attention mechanism pays attention to an attention weight between each token and a preceding token of the token, and does not pay attention to an attention weight between each token and a succeeding token of the token. A succeeding token of any token refers to a token that is in a text and that is arranged after the token. A right matrix in FIG. 1 represents a bias, including a relative positional encoding between paired tokens in the text. For example, a relative positional encoding between the 6^{th} token and the 1^{st} token is m*[−(6−1)]=m*(−5). Consistent with the attention weight matrix, the relative positional encoding focuses on a relative positional encoding between each token and a preceding token of the token, and does not focus on a relative positional encoding between each token and a succeeding token of the token.

Based on the foregoing descriptions about the key terms such as text processing, the attention mechanism, and the relative positional encoding, it can be found that the order of the tokens in the text can be introduced into the attention mechanism through the relative positional encoding, whereby the attention mechanism can capture the order of the text tokens in the text. However, in a text processing process, improving generalization performance of a text processing model and enhancing a length extrapolation capability of the text processing model are urgent requirements of text processing. The length extrapolation capability may be understood as a specific reflection of generalization performance on a text length. Improving generalization performance of the text processing model is a similar concept to enhancing the length extrapolation capability of the text processing model, which refers to that for a text processing model trained based on a short sequence (the short sequence refers to a text with a short text length), a text processing effect of processing a long sequence (the long sequence refers to a text with a long text length) by the text processing model is improved, to enable the text processing model to achieve good performance for the long sequence.

Length extrapolation means that a text length processed by the text processing model in an inference process exceeds a text length processed by the text processing model in a training process. After the length extrapolation, a relative positional encoding between paired tokens in a text is also extrapolated. In the Alibi relative positional encoding method, the relative positional encoding between the paired tokens in the text may be expressed as formula 6 below:

$$AlibiBias ( i , j ) = - m * ( i - j ) \qquad formula 6$$

where AlibiBias(i, j) denotes the relative positional encoding between the i^{th} token and the j^{th} token in the text, i indicates that an arrangement position of the i^{th} token in the text is the i^{th} position, j indicates that an arrangement position of the j^{th} token in the text is the j^{th} position, and i≥j.

It is assumed that the maximum sequence length (the maximum sequence length refers to a maximum text length) processed by the text processing model in the training process is l₁, and a maximum sequence length required in an actual service needs to be extrapolated to l₂ (l₂>l₁). The embodiments of the present disclosure provide two relative positional encoding extrapolation methods.

A first relative positional encoding extrapolation method is a direct extrapolation method. The direct extrapolation method refers to that a relative positional encoding of the text obtained after the length extrapolation is directly calculated based on formula 6 above. That is, the relative positional encoding of the text obtained after the length extrapolation is directly calculated based on the Alibi relative positional encoding method. In this method, a value range of formula 6 is [−m*(l₁−1), 0]. If it is expected that the maximum sequence length is extrapolated to l₂ during inference based on formula 6 above, the relative positional encoding of the text obtained after the length extrapolation is directly calculated, and a value range of an extrapolated positional encoding bias is [−m*(l₂−1), 0].

A second relative positional encoding extrapolation method is an interpolation and extrapolation method. The interpolation and extrapolation method refers to that a value range [−m*(l₁−1), 0] is retained, an interval between each relative positional encoding is changed correspondingly, and interpolate each relative positional encoding geometrically into a value range [−m*(l₁−1), 0]. A modification in the second relative positional encoding extrapolation method may be specifically reflected in a relative distance coefficient m. For reference, refer to formula 7 below:

$$AlibiBiasInter ( i , j ) = - m * \frac{{l}_{1}}{{l}_{2}} * ( i - j ) \qquad formula 7$$

That is, in the second relative positional encoding extrapolation method, an original relative distance coefficient m is modified into a relative distance coefficient

$$m * \frac{{l}_{1}}{{l}_{2}}$$

having a geometric interpolation function.

Neither of the foregoing two relative positional encoding extrapolation have achieved good effects in improving the generalization performance of the text processing model nor enhancing the extrapolation capability of the text processing model. The reason is as follows: the direct extrapolation method causes a large change in the value domain of the relative positional encoding, and a capability of the model to generalize a token of an extrapolated part is insufficient. The interpolation and extrapolation method may cause the interval between the relative positional encodings to be shortened, and distribution of attention weights between adjacent tokens is significantly affected. In the two relative positional encoding extrapolation methods, only the sequence length in the training process is considered, and during inference, directly extrapolation is performed and a case in which the text processing model may be further fine-tuned is not considered.

Based on this, the embodiments of the present disclosure provide a text processing method. The text processing method provides an innovative relative positional encoding extrapolation method based on the foregoing two relative positional encoding extrapolation methods. The innovative relative positional encoding extrapolation method is a novel functional positional encoding method, which is an Alibi relative positional encoding method based on piecewise interpolation, and may be referred to as a Leaky Alibi relative positional encoding method. A relative positional encoding obtained by this method has good extrapolation performance. Specifically, different from conventional relative positional encoding, the text processing method provided in the embodiments of the present disclosure comprehensively considers performance of relative positional encoding at an unseen position and impact on a local attention mechanism. The novel functional positional encoding method is a novel piecewise positional encoding bias function. For two tokens with a short relative distance (namely, close tokens), a relative positional encoding interval between the two tokens remains unchanged, whereby distribution characteristics of local attention in the text processing model are preserved. For two tokens with a long relative distance (namely, remote tokens), relative positional encoding employs interpolation to control a value range of a positional bias, whereby the generalization capability of the text processing model is improved effectively when the relative positional encoding is extrapolated. In addition, according to the text processing method provided in the embodiments of the present disclosure, a parameter (the parameter may be referred to as a distance threshold) is further introduced to distinguish whether a relative distance between paired tokens is short or long. The parameter also allows for simple and effective extension to a fine-tuning scenario. During fine-tuning, the parameter may be set as a learnable model parameter, thereby scalability of the text processing model is improved.

The text processing method provided in the embodiments of the present disclosure may be integrated into the text processing model. The text processing method provided in the embodiments of the present disclosure may be performed by a computer device. The computer device may be a terminal device or a server on which the text processing model is deployed. The terminal device involved in the embodiments of the present disclosure may include, but is not limited to, any one of the following: a smartphone, a tablet computer, a notebook computer, a desktop computer, a smartwatch, a smart home appliance, a smart voice interaction device, an in-vehicle terminal, and an aircraft. The server involved in the embodiments of the present disclosure may be an independent physical server, may be a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. This is not limited in the embodiments of the present disclosure.

An application scenario of the text processing method is not limited in the embodiments of the present disclosure. The text processing method may be applied to any application scenario in which text semantic understanding needs to be performed on a long text. For example, the text processing method provided in the embodiments of the present disclosure may be applied to a text processing scenario such as long-text understanding, long-text generation, or a multi-turn dialog.

Specifically, a long-text understanding scenario refers to a text processing scenario in which semantic understanding is performed on a to-be-processed text, to generate a semantic understanding result of the to-be-processed text. That is, the generated semantic understanding result is a semantically associated text. For example, the semantic understanding result may be a text summary generated after semantic understanding is performed on the to-be-processed text. For another example, the semantic understanding result may be a keyword extracted from the to-be-processed text after semantic understanding is performed on the to-be-processed text. For still another example, the semantic understanding result may be an information retrieval result for semantics of the to-be-processed text after semantic understanding is performed on the to-be-processed text. FIG. 2 is a schematic diagram of a long-text understanding scenario. An example in which the long-text understanding scenario is a text summary generation scenario is used. A text processing model is deployed on a terminal device used by a service object. The service object may submit a text summary generation task for a to-be-processed text in the terminal device. The text processing model deployed on the terminal device may output a generated text summary to the service object after performing semantic understanding on the to-be-processed text.

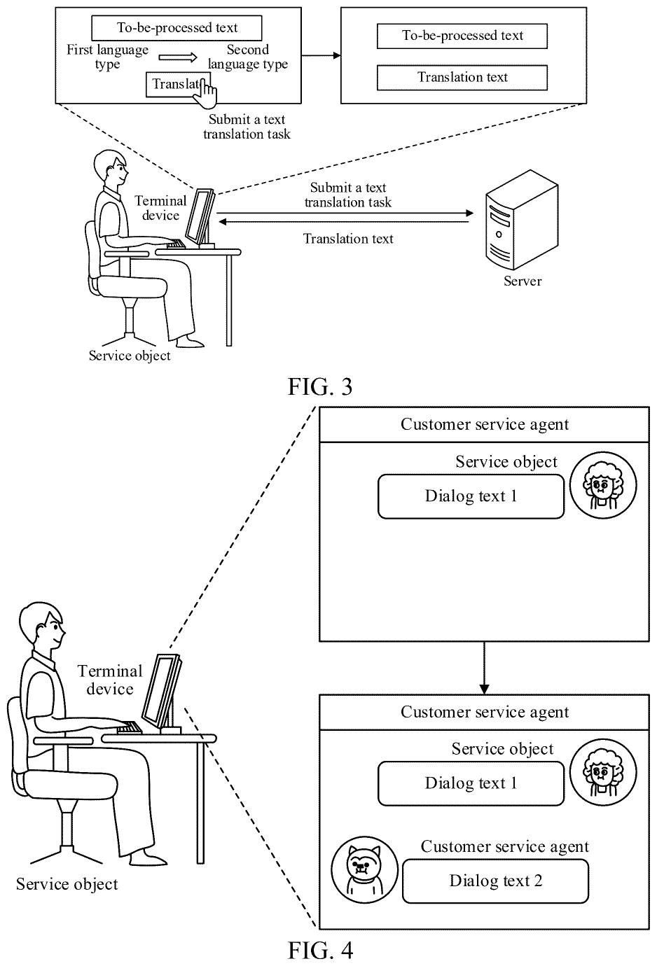

A long-text generation scenario refers to a text processing scenario in which semantic understanding is performed on a to-be-processed text to generate a semantically associated text meeting a text generation requirement. For example, an outline generation requirement is specified in the to-be-processed text, and the semantically associated text may be an outline text meeting the outline generation requirement. For another example, an academic writing requirement is specified in the to-be-processed text, and the semantically associated text may be an academic text meeting the academic writing requirement. For still another example, a text translation requirement is specified in the to-be-processed text, and the semantically associated text may be a translation text meeting the text translation requirement. FIG. 3 is a schematic diagram of a long-text generation scenario. An example in which the long-text generation scenario is a text translation scenario is used. A service object may submit a text translation task to a server through a used terminal device, and a text translation requirement is translation from a first language type to a second language type. A text processing model is deployed on the server. After performing semantic understanding on the to-be-processed text, the text processing model deployed in the server may generate a translation text meeting the text translation requirement, and transmits the translation text to the terminal device. The terminal device may output the translation text meeting the text translation requirement to the service object.

A multi-turn dialog scenario refers to a text processing scenario in which semantic understanding is performed on a historical dialog text, to generate a new dialog text that is semantically associated with the historical dialog text. That is, the semantically associated text is a new dialog text that is semantically associated with a historical multi-turn dialog text. For example, the multi-turn dialog scenario is specifically a multi-turn human-computer interaction scenario, a dialog assistant scenario, or the like. The multi-turn human-computer interaction scenario is similar to the dialog assistant scenario, and both the multi-turn human-computer interaction scenario and the dialog assistant scenario refer to a scenario in which a dialog is performed with a virtual robot. FIG. 4 is a schematic diagram of a multi-turn dialog scenario. A text processing model is deployed on a terminal device used by a service object. The service object may perform a dialog with a virtual robot (for example, a dialog name of the virtual robot is customer service agent) on the terminal device. After performing semantic understanding on dialog content (such as, “dialog text 1” in FIG. 4) of the service object, the text processing model deployed on the terminal device outputs dialog content (such as, “dialog text 2” in FIG. 4) of the virtual robot to the service object in the style of the virtual robot. After content of a multi-turn dialog between the service object and the virtual robot is generated, the text processing model may perform comprehensive semantic understanding on content of the historical multi-turn dialog between the service object and the virtual robot, and then outputs the dialog content of the virtual robot to the service object in the style of the virtual robot.

It is not difficult to find that, in all of the foregoing text processing scenarios, a text length inputted into and/or outputted from the text processing model is required to be significantly longer than that of common question-answer content. That requires the text processing model to better process an input/output sequence with an excessively long length. Therefore, a higher requirement is placed on the extrapolation performance of relative positional encoding. The text processing method provided in the embodiments of the present disclosure is intended to enhance a capability of a large language model (namely, the text processing model) to extrapolate a token length, to enable the text processing model to achieve good performance without a large amount of fine tuning when processing a longer input/output text task. The text processing method provided in the embodiments of the present disclosure can achieve a good text processing effect in the foregoing text processing scenarios. In the text understanding scenario, the method can help the text processing model improve a capability of understanding long texts in a case that a training text length is limited. In the text generation scenario, the method can help the text processing model improve a capability of generating long texts in a case that the training text length is limited. In the multi-turn dialog scenario, the method can help the text processing model improve a capability of answering long texts in a case that the training text length is limited.

The text processing method provided in the embodiments of the present disclosure is further described in detail below with reference to the accompanying drawings.

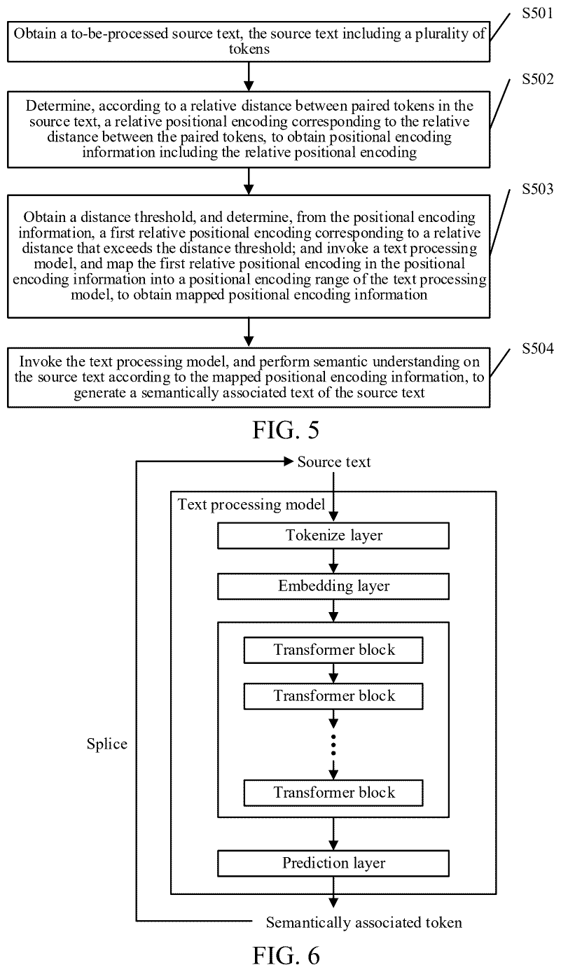

The embodiments of the present disclosure provide a text processing method. In the text processing method, a model structure of a text processing model and a text processing process of the text processing model are primarily described. The text processing method may be performed by a computer device on which a text processing model is deployed, and the computer device may be, for example, a terminal device or a server. As shown in FIG. 5, the data processing method may include, but is not limited to, operation S501 to operation S504.

S501: Obtain a to-be-processed source text, the source text including a plurality of tokens.

The source text refers to any to-be-processed text. The source text may include a plurality of tokens. The token refers to a word of a natural language or a word of the natural language in the source text. A text length of the source text is a second text length. The second text length refers to a quantity of tokens included in the source text.

Before a specific text processing process is described with reference to operation S502 to operation S504 in the embodiment of the present disclosure, a model structure of the text processing model is first described herein, and subsequently, the text processing process of the text processing model is described with reference to the model structure of the text processing model. As shown in FIG. 6, the text processing model may be a model including a tokenize layer, an embedding layer, a plurality of transformer blocks, and a prediction layer. A connection relationship between components of the text processing model is as follows: the source text is inputted into the tokenize layer, an output end of the tokenize layer is connected to an input end of the embedding layer, and an output end of the embedding layer is connected to an input end of the 1^{st} transformer block, an output end of the 1^{st} transformer block is connected to an input end of the 2^{nd} transformer block, an output end of the 2^{nd} transformer block is connected to an input end of the 3^{rd} transformer block, and by analogy, an output end of the last transformer block is connected to an input end of the prediction layer, and an output of the prediction layer may be used as a text processing result outputted by the text processing model.

1. Tokenize layer: the tokenize layer may be configured to perform tokenization on an input in a form of a natural language, and convert the input into a form of a token sequence. Tokenization refers to word segmentation processing. That is, the tokenize layer may be configured to perform word segmentation processing on the inputted source text, to obtain the plurality of tokens included in the source text.

2. Embedding layer: the token sequence may be encoded into a form of an embedding through the embedding layer. Specifically, the embedding layer may be configured to perform representation analysis on each token included in the source text, to obtain an embedding of each token. The embedding of each token may be configured for uniquely representing a corresponding token.

3. Transformer block: the transformer block may alternatively be referred to as an attention fusion module, and a function of the transformer block is primarily implemented based on the attention mechanism. Token embeddings are sequentially inputted into the plurality of transformer blocks to perform attention fusion, whereby feature semantics is enriched. That is, the plurality of transformer blocks included in the text processing model may be configured to perform semantic understanding (or may be referred to as attention fusion) on each token in the source text, to obtain a semantic feature of each token in the source text.

In the text processing model, the plurality of transformer blocks are disposed, to perform semantic understanding from shallow to deep on each token in the source text. Specifically, after the embedding of each token in the source text is inputted into the 1^{st} transformer block, the 1^{st} transformer block may perform semantic understanding on each token, to obtain a semantic understanding result of each token in the source text under the 1^{st} transformer block. After the semantic understanding result of each token in the source text under the 1^{st} transformer block is inputted into the 2^{nd} transformer block, the 2^{nd} transformer block may perform semantic understanding on each token, to obtain a semantic understanding result of each token in the source text under the 2^{nd} transformer block. By analogy, a semantic understanding result of each token in the source text under the last transformer block may be obtained, and the semantic understanding result of each token in the source text under the last transformer block may be used as a final semantic feature of each token in the source text. In the foregoing semantic understanding process of the plurality of transformer blocks, the transformer block that preferentially performs semantic understanding outputs a shallow semantic feature of a token, and the transformer block that subsequently performs semantic understanding outputs a deep semantic feature of the token. Compared with the shallow semantic feature, the deep semantic feature is richer and has a stronger capability of distinguishing between text words. In addition, processes of performing semantic understanding by the transformer blocks are the same, and semantic understanding is performed based on the attention mechanism. For the semantic understanding process based on the attention mechanism, refer to the related content of formula 1 to formula 5 above.

The text processing method provided in the embodiments of the present disclosure relates to improvement of a relative positional encoding between paired tokens in the source text. The relative positional encoding is applied to an attention weight of the attention mechanism. Therefore, improvement of the embodiments of the present disclosure is primarily applied to the transformer block.

4. Prediction layer: the semantic feature of each token in the source text may be finally configured for predicting an embedding of a next token in the sequence, and the embedding of the next token is decoded to restore a form of a natural language. That is, the prediction layer may be configured to predict a semantically associated text of the source text according to the semantic feature of each token in the source text. In addition, in a process of predicting the semantically associated text of the source text, the text processing model can predict only one semantically associated token at a time, and the predicted semantically associated token needs to be spliced with the inputted source text and used as a new source text in re-prediction of a new semantically associated token. Subsequently, a new semantically associated token is recursively predicted until a recursion termination condition is satisfied, and semantically associated tokens obtained through prediction may be spliced into an entire outputted semantically associated text.

Based on the model structure of the text processing model, an overall text processing process of the text processing model may include: performing word segmentation on the source text by invoking the tokenize layer of the text processing model, to obtain the plurality of tokens included in the source text; performing representation analysis on each token in the source text by invoking the embedding layer of the text processing model, to obtain the embedding of each token in the source text; performing semantic understanding on each token in the source text based on the embedding of each token in the source text by invoking the plurality of transformer blocks in the text processing model, to obtain the semantic feature of each token in the source text; and performing prediction on the source text according to the semantic feature of each token in the source text by invoking the prediction layer of the text processing model, to obtain the predicted semantically associated token. Then, the predicted semantically associated token may be spliced with the source text and used as a new source text. The foregoing text processing process is repeated, and a new semantically associated token is recursively predicted until the recursion termination condition is satisfied. The text obtained by splicing all predicted semantically associated tokens is outputted as the semantically associated text of the source text.

Based on the model structure of the text processing model and the overall text processing process of the text processing model, technical details in the text processing process are described below with reference to operation S502 to operation S504.

S502: Determine, according to a relative distance between paired tokens in the source text, a relative positional encoding corresponding to the relative distance between the paired tokens, to obtain positional encoding information including the relative positional encoding.

The positional encoding information corresponding to the source text may be obtained. The positional encoding information includes the relative positional encoding between the paired tokens in the source text, and the relative positional encoding between the paired tokens is determined according to the relative distance between the paired tokens in the source text.

The positional encoding information corresponding to the source text may include the relative positional encoding between the paired tokens in the source text, and the relative positional encoding between the paired tokens may be determined according to the relative distance between the paired tokens in the source text. The relative positional encoding between the paired tokens may be calculated according to the relative distance between the paired tokens in the source text based on the Alibi relative positional encoding method recorded in formula 6 above.

In some embodiments, determining, according to the relative distance between the paired tokens in the source text, the relative positional encoding corresponding to the relative distance between the paired tokens includes: obtaining the relative distance between the paired tokens in the source text; and obtaining a relative distance coefficient, and calculating the relative positional encoding between the paired tokens according to the relative distance coefficient and the relative distance between the paired tokens in the source text.

Specifically, the relative distance between the paired tokens in the source text specifically refers to a distance between the paired tokens in the source text, and is a difference between position sequence numbers of arrangement positions of the paired tokens in the source text. For example, in formula 6 above, the i^{th} token is arranged at the i^{th} position in the source text, and a position sequence number is i; and the j^{th} token is arranged at the j^{th} position in the source text, and a position sequence number is j. Then, a relative distance between the i^{th} token and the j^{th} token is (i−j). The relative positional encoding between the paired tokens may be calculated according to the relative distance between the paired tokens in the source text and a relative distance coefficient m. For example, a relative positional encoding between the i^{th} token and the j^{th} token is −m*(i−j).

Further, as described above, in a process of calculating an attention feature (namely, a semantic feature), an attention mechanism pays attention to a similarity between each token and a preceding token of the token, and correspondingly, relative positional encoding also considers a relative positional encoding between each token and a preceding token of the token. That is, the positional encoding information corresponding to the source text may include a relative positional encoding between each token in the source text and a preceding token of the token, and the preceding token of each token includes the token and a token arranged before the token in the source text.

In addition, the relative positional encoding between the paired tokens in the source text may be applied to a plurality of attention fusion modules (namely, transformer blocks), to participate in calculation of an attention weight. Relative distance coefficients corresponding to the plurality of attention fusion modules may be the same or different. If the relative distance coefficients corresponding to the attention fusion modules are the same, positional encoding information introduced into the attention fusion modules is the same. In this way, the positional encoding information does not need to be calculated separately for the attention fusion modules, whereby text processing efficiency can be improved to some extent. If the relative distance coefficients corresponding to the attention fusion modules are different, positional encoding information introduced into the attention fusion modules is different. In this way, different relative distance coefficients may be configured for semantic understanding requirements of each attention fusion module, to improve semantic understanding accuracy of each attention fusion module, whereby text processing accuracy can be improved to some extent.

In an embodiment, each attention fusion module may include a plurality of attention fusions, and results of the plurality of attention fusions are spliced to obtain an output result of each attention fusion module. It may be further understood that, an attention mechanism used by each attention fusion module may be a multi-head attention mechanism. The multi-head attention mechanism refers to that in an attention fusion process of each attention fusion module, an input is mapped to different dimensions, one attention fusion is performed on each dimension, and finally results of the attention fusion on the dimensions are spliced into the output result of each attention fusion module. In the multi-head attention mechanism, relative distance coefficients corresponding to attention fusions may be different. To be specific, values of the relative distance coefficient m may be different at different heads. In this way, different relative distance coefficients may be configured for mapping requirements on different dimensions, to improve semantic understanding accuracy on each dimension, whereby text processing accuracy can be improved to some extent.

S503: Obtain a distance threshold, and determine, from the positional encoding information, a first relative positional encoding corresponding to a relative distance that exceeds the distance threshold; and invoke a text processing model, and map the first relative positional encoding in the positional encoding information into a positional encoding range of the text processing model, to obtain mapped positional encoding information.

The text processing model may be invoked, and the first relative positional encoding in the positional encoding information is mapped into the positional encoding range of the text processing model, to obtain a target relative positional encoding corresponding to the first relative positional encoding. The first relative positional encoding is a relative positional encoding that is in the positional encoding information and that corresponds to a relative distance exceeding the distance threshold.

After the positional encoding information (including the relative positional encoding between the paired tokens in the source text) corresponding to the source text is obtained, the text processing model may be invoked, and the first relative positional encoding in the positional encoding information is mapped into the positional encoding range of the text processing model, to obtain the target relative positional encoding corresponding to the first relative positional encoding; and the text processing model may be invoked to determine a second relative positional encoding in the positional encoding information as a target relative positional encoding corresponding to the second relative positional encoding. The first relative positional encoding is a relative positional encoding that is in the positional encoding information and that corresponds to a relative distance exceeding (greater than) the distance threshold, and the second relative positional encoding is a relative positional encoding that is in the positional encoding information and that corresponds to a relative distance not exceeding (less than or equal to) the distance threshold. The mapped positional encoding information may include the target relative positional encoding corresponding to the first relative positional encoding and the target relative positional encoding corresponding to the second relative positional encoding.

The positional encoding range of the text processing model refers to a positional encoding range within which the text processing model can achieve a good text processing effect. After the relative positional encoding within the positional encoding range is introduced into the attention mechanism, the text processing model can achieve a good text processing effect. The positional encoding range of the text processing model may be determined according to a first text length. The first text length refers to a maximum text length processed by the text processing model in a training process. The positional encoding range of the text processing model refers to a value range of a relative positional encoding between paired tokens in a text with the maximum text length. For example, when the first text length is l₁, the positional encoding range of the text processing model is [−m*(l₁−1), 0]. When a text length (namely, a second text length) of the source text is greater than the first text length, a positional encoding range (namely, a value range of the relative positional encoding between the paired tokens in the source text) corresponding to the source text exceeds the positional encoding range of the text processing model. For example, when the second text length is l₂ (l₂>l₁), the positional encoding range of the text processing model is [−m*(l₂−1), 0]. [−m*(l₂−1), 0] exceeds [−m*(l₁−1), 0], which affects a text processing effect of the text processing model. Therefore, in the embodiments of the present disclosure, the relative positional encoding between the paired tokens in the source text is mapped into the positional encoding range of the text processing model, to improve a text processing effect of the text processing model on long texts (the long text refers to a text with a text length exceeding the maximum text length that has appeared in the training processing of the text processing model).

In a mapping process, the embodiments of the present disclosure provide a user-defined parameter. The user-defined parameter is the distance threshold within a value range [0, l₁]. The physical meaning of the parameter is an inflection point of the relative positional encoding. When the relative distance between the paired tokens in the source text (namely, the distance between the paired tokens in the source text) is less than or equal to the distance threshold, the relative positional encoding between the paired tokens remains unchanged, that is, is consistent with a relative positional encoding obtained through encoding by the Alibi relative positional encoding method. In this way, characteristics of a local attention mechanism can remain unchanged within a widow m, to reduce impact on a local attention score and maintain a dependence relationship between adjacent tokens. When the relative distance (namely, the distance between the paired tokens in the source text) between the paired tokens in the source text is greater than the distance threshold and is less than an extended second text length l₂, the positional encoding range [−m*(l₁−1), 0] (namely, the value range of the relative positional encoding, corresponding to the first text length l₁, in the text processing model) of the text processing model may remain unchanged, and the relative positional encoding between the paired tokens is mapped into the positional encoding range of the text processing model. In this way, the value range of the relative positional encoding is consistent before and after extrapolation, which reduces impact of an unseen value range on generalization of the relative positional encoding.

S504: Invoke the text processing model, and perform semantic understanding on the source text according to the mapped positional encoding information, to generate a semantically associated text of the source text.

As described above, the text processing model can only generate one semantically associated token when performing semantic understanding once. Therefore, the text processing model needs to perform recursive semantic understanding to generate the semantically associated text obtained by splicing a plurality of semantically associated tokens. Recursive semantic understanding refers to continuously performing new semantic understanding based on previous semantic understanding until a recursion termination condition is satisfied. A text corresponding to the new semantic understanding is obtained by splicing a text corresponding to the previous semantic understanding with a semantically associated token generated through the previous semantic understanding.

Specifically, with reference to operation S502 and operation S503, after the mapped positional encoding information is obtained, the text processing model may be invoked, and the 1^{st} semantic understanding is performed on the source text according to the mapped positional encoding information, to generate a semantically associated token corresponding to the 1^{st} semantic understanding. A text formed by the semantically associated token corresponding to the 1^{st} semantic understanding and the source text is used as a new source text, and the text processing model is invoked again to perform recursive semantic understanding until the recursion termination condition is satisfied. After the recursion termination condition is satisfied, a text formed by the semantically associated token corresponding to the 1^{st} semantic understanding and semantically associated tokens obtained through recursive semantic understanding is determined as the semantically associated text of the source text.

Satisfying the recursion termination condition includes any one of the following: the semantically associated token obtained through prediction is a specified token, for example, the specified token refers to a special terminator; and a quantity of semantically associated tokens obtained through prediction reaches a specified quantity, for example, a text summary including 500 tokens needs to be generated. When the quantity of semantically associated tokens obtained through prediction reaches 500, the recursion termination condition is satisfied.

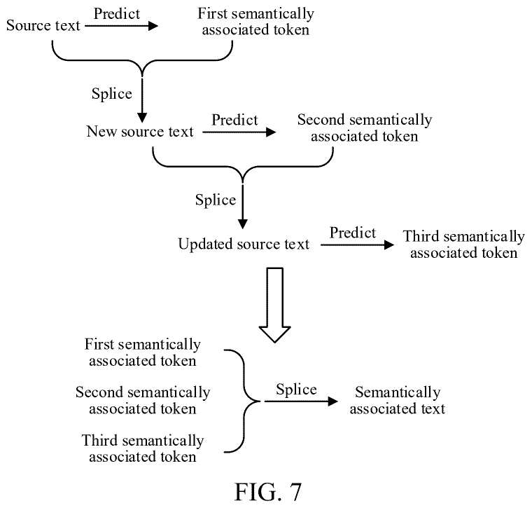

For example, as shown in FIG. 7, the recursion termination condition is satisfied after the text processing model is invoked to perform semantic understanding for three times. The text processing model is invoked, and the 1^{st} semantic understanding is performed on the source text, to generate a first semantically associated token. After the source text and the first semantically associated token are formed into a new source text, the text processing model is invoked, and the 2^{nd} semantic understanding is performed on the new source text, to generate a second semantically associated token. After the new source text and the second semantically associated token are spliced into an updated source text, the text processing model is invoked, and the 3^{rd} semantic understanding is performed on the updated source text, to generate a third semantically associated token. Finally, a text obtained by splicing the first semantically associated token, the second semantically associated token, and the third semantically associated token may be used as the semantically associated token of the source text for output.

In the embodiments of the present disclosure, when the text length of the source text exceeds the text length processed by the text processing model in the training process, for the relative positional encoding between the paired tokens in the source text, the relative positional encoding may be mapped into the positional encoding range of the text processing model when the relative distance corresponding to the relative positional encoding is greater than the distance threshold, and text processing is performed on the source text based on the relative positional encoding within the positional encoding range, whereby the text processing model maintains a good text processing effect. When the relative distance corresponding to the relative positional encoding is less than or equal to the distance threshold, the original relative positional encoding may remain unchanged, to avoid impact on attention weight distribution between adjacent tokens after mapping.

That is, in the embodiments of the present disclosure, the text length processed by the text processing model may be extended while it is ensured that the text processing effect of the text processing model is not affected, whereby the text processing model can process a text with a text length exceeding a length of a training text.

It is proved in an experiment that, compared with the Alibi relative positional encoding method, the relative positional encoding method provided in the embodiments of the present disclosure can effectively extend a context window of a text length from 2k (2k refers to 2,000 tokens) to 8k (8k refers to 8,000 tokens), and achieves an accuracy improvement of over 10% on long-text validation sets.

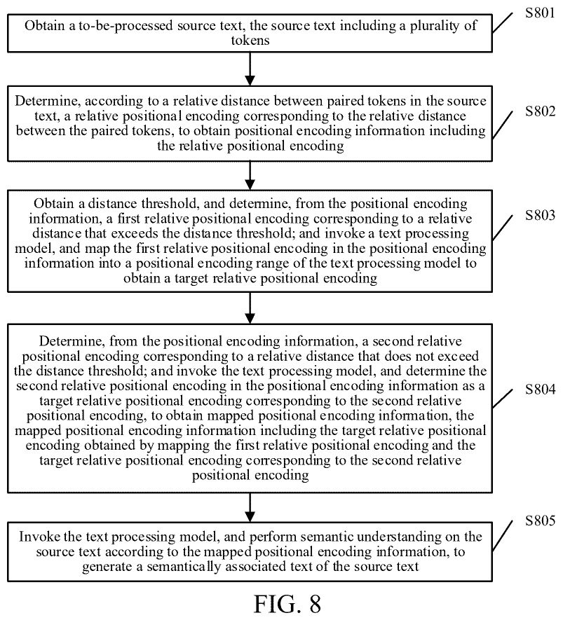

The embodiments of the present disclosure provide a text processing method. In the text processing method, a specific mapping process of a relative positional encoding and a method for setting a distance threshold are primarily described. The text processing method may be performed by a computer device on which a text processing model is deployed, and the computer device may be, for example, a terminal device or a server. As shown in FIG. 8, the data processing method may include, but is not limited to, operation S801 to operation S805.

S801: Obtain a to-be-processed source text, the source text including a plurality of tokens.

In the embodiments of the present disclosure, a process of performing operation S801 is the same as the process of performing operation S501 in the foregoing embodiment shown in FIG. 5. For details, refer to related descriptions of operation S501 in the foregoing embodiment shown in FIG. 5. Details are not described herein again.

S802: Determine, according to a relative distance between paired tokens in the source text, a relative positional encoding corresponding to the relative distance between the paired tokens, to obtain positional encoding information including the relative positional encoding.

In the embodiments of the present disclosure, a process of performing operation S802 is the same as the process of performing operation S502 in the foregoing embodiment shown in FIG. 5. For details, refer to related descriptions of operation S502 in the foregoing embodiment shown in FIG. 5. Details are not described herein again.

S803: Obtain a distance threshold, and determine, from the positional encoding information, a first relative positional encoding corresponding to a relative distance that exceeds the distance threshold; and invoke a text processing model, and map the first relative positional encoding in the positional encoding information into a positional encoding range of the text processing model to obtain a target relative positional encoding.

In some embodiments, the source text includes N tokens, and the i^{th} token in the N tokens is arranged at the i^{th} position in the source text, where N is an integer greater than 1, and i is an integer less than or equal to N. The positional encoding information includes a relative positional encoding between the i^{th} token and each preceding token of the i^{th} token. The preceding token is any token arranged from the 1^{st} position to the i^{th} position in the source text. Invoking the text processing model, and mapping the first relative positional encoding in the positional encoding information into the positional encoding range of the text processing model, to obtain the mapped positional encoding information includes: invoking the text processing model, and mapping the first relative positional encoding in the relative positional encoding between the i^{th} token and each preceding token to a target relative positional encoding that is within the positional encoding range of the text processing model and that corresponds to the first relative positional encoding, to obtain the mapped positional encoding information.

For ease of understanding, any token (any token may be represented as the i^{th} token) in the source text is used as an example herein to describe a process of mapping a relative positional encoding of the i^{th} token is described:

The source text may include N tokens, any one of the N tokens may be represented as the i^{th} token, and the i^{th} token is arranged at the i^{th} position in the source text, where Nis an integer greater than 1, and i is an integer less than or equal to N. The positional encoding information may include a relative positional encoding between the i^{th} token and each preceding token of the i^{th} token. Any preceding token refers to any token arranged from the 1^{st} position to the i^{th} position in the source text. That is, the preceding token of the i^{th} token is the 1^{st} token, the 2^{nd} token, . . . , or the i^{th} token in the source text.

Based on this, the text processing model may be invoked, and the first relative positional encoding in the relative positional encoding between the i^{th} token and each preceding token into the positional encoding range of the text processing model, to obtain the target relative positional encoding corresponding to the first relative positional encoding. The first relative positional encoding is a relative positional encoding that is in the relative positional encoding between the i^{th} token and each preceding token and that corresponds to a relative distance exceeding the distance threshold.

Further, the essence of mapping is interpolation, specifically, interpolation into the positional encoding range of the text processing model. For ease of understanding, the relative positional encoding between the i^{th} token and any preceding token of the i^{th} token (any preceding token of the i^{th} token may be represented as the j^{th} preceding token, where j is a positive integer less than or equal to i) is used as an example herein, and a process of mapping the relative positional encoding between the i^{th} token and the j^{th} preceding token is described. Specifically, when a relative distance between the i^{th} token and the j^{th} preceding token exceeds the distance threshold, an interpolation function may be obtained. The interpolation function is generated according to a second text length, a first text length, and the distance threshold. The second text length refers to a text length of the source text, the text length of the source text refers to a quantity of tokens included in the source text. The first text length is a maximum text length in text lengths of texts processed by the text processing model in a training process. A value range of the interpolation function is the positional encoding range of the text processing model. Then, interpolation may be performed on a first relative positional encoding between the i^{th} token and the j^{th} preceding token according to the interpolation function, to obtain a target relative positional encoding corresponding to the first relative positional encoding between the i^{th} token and the j^{th} preceding token.

S804: Determine, from the positional encoding information, a second relative positional encoding corresponding to a relative distance that does not exceed the distance threshold; and invoke the text processing model, and determine the second relative positional encoding in the positional encoding information as a target relative positional encoding corresponding to the second relative positional encoding, to obtain mapped positional encoding information, the mapped positional encoding information including the target relative positional encoding obtained by mapping the first relative positional encoding and the target relative positional encoding corresponding to the second relative positional encoding.

For ease of understanding, any token (any token may be represented as the i^{th} token) in the source text is used as an example herein to describe a process of mapping a relative positional encoding of the i^{th} token is described:

Invoking the text processing model, and determining the second relative positional encoding in the positional encoding information as the target relative positional encoding corresponding to the second relative positional encoding includes: invoking the text processing model, and determining the second relative positional encoding in a relative positional encoding between the i^{th} token and each preceding token as the target relative positional encoding corresponding to the second relative positional encoding.

The text processing model may be invoked to determine the second relative positional encoding in the relative positional encoding between the i^{th} token and each preceding token as the target relative positional encoding corresponding to the second relative positional encoding. The second relative positional encoding is a relative positional encoding that is in the relative positional encoding between the i^{th} token and each preceding token and that corresponds to a relative distance that does not exceed the distance threshold.

In conclusion, in operation S803 and operation S804, the process of mapping the relative positional encoding of the i^{th} token may be summarized as formula 8 below (formula 8 may alternatively be expressed as a piecewise function form of formula 9 below):

$$LeakyAlibi ( i , j , φ ) = - m * min ( ( i - j ) , \frac{{I}_{1} - φ}{{I}_{2} - φ} ( i - j ) + \frac{{I}_{2} - {I}_{1}}{{I}_{2} - φ} * φ ) \qquad formula 8$$

$$LeakyAlibi ( i , j , φ ) = \{ \begin{matrix}- m * ( \frac{{l}_{1} - φ}{{l}_{2} - φ} ( i - j ) + \frac{{l}_{2} - {l}_{1}}{{l}_{2} - φ} * φ ) , i - j > φ \\ - m * ( i - j ) , i - j \leq φ\end{matrix} \qquad formula 9$$

where LeakyAlibi(i, j, ) denotes the target relative positional encoding between the i^{th} token and the j^{th} preceding token, l₁ denotes the first text length, l₂ denotes the second text length, and φ denotes the distance threshold. It can be learned from formula 8 and formula 9 above that, when the relative distance between the i^{th} token and the j^{th} preceding token (namely, a distance between the i^{th} token and the j^{th} preceding token) is greater than the distance threshold φ, the first relative positional encoding [−m*(i−j)] between the i^{th} token and the j^{th} preceding token may be mapped into the positional encoding range of the text processing model (namely, a value range [−m*(l₁−1), 0] corresponding to the text processing model), actually, mapped to the target relative positional encoding

$$[ - m * ( \frac{{l}_{1} - φ}{{l}_{2} - φ} ( i - j ) + \frac{{l}_{2} - {l}_{1}}{{l}_{2} - φ} * φ ) ] .$$

When the relative distance between the i^{th} token and the j^{th} preceding token (namely, the distance between the i^{th} token and the j^{th} preceding token) is less than or equal to the distance threshold φ, the second relative positional encoding [−m*(i−j)] between the i^{th} token and the j^{th} preceding token may remain unchanged.

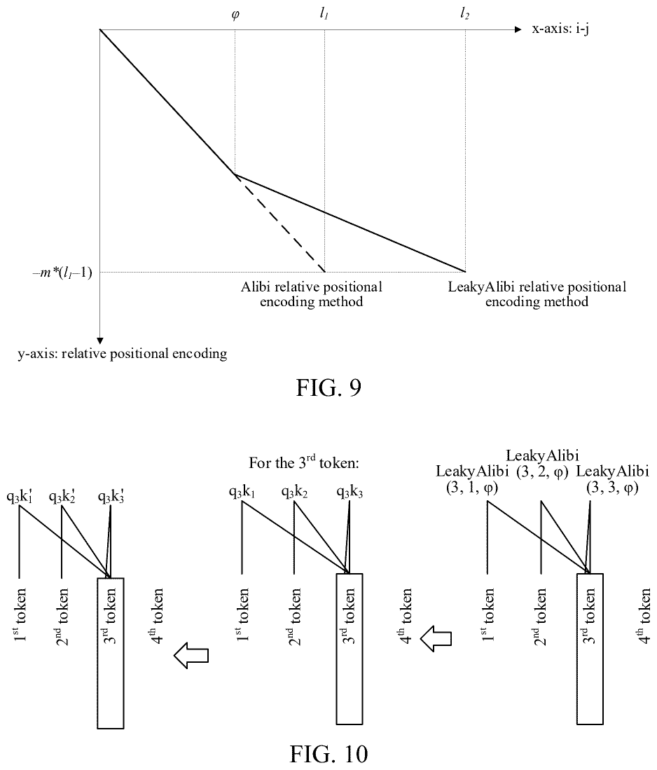

FIG. 9 is a schematic diagram of a comparison of a relative positional encoding in an Alibi relative positional encoding method (which may be understood as before text length extrapolation) and a relative positional encoding in a LeakyAlibi relative positional encoding method (which may be understood as after text length extrapolation) according to an embodiment of the present disclosure. It may be learned that, first, a relationship between a relative positional encoding and a relative distance is the same in both the Alibi relative positional encoding method and the LeakyAlibi relative positional encoding method. A longer relative distance between tokens (namely, a longer distance) indicates a larger absolute value of a relative positional encoding. On the contrary, a shorter relative distance between tokens (namely, a shorter distance) indicates a smaller absolute value of a relative positional encoding. Second, in the Alibi relative positional encoding method and the LeakyAlibi relative positional encoding method, the value range of the relative positional encoding remains consistent. That is, before and after text length extrapolation, the value range of the relative positional encoding remains consistent, whereby impact of an unseen value range on generalization of the relative positional encoding is reduced, and a text processing effect of the text processing model after text length extrapolation. Third, before an inflection point (the inflection point refers to the distance threshold q), the relative positional encodings in the Alibi relative positional encoding method and the LeakyAlibi relative positional encoding method are the same, which results in little impact on a local attention weight and remains a dependency relationship between adjacent tokens. At the inflection point (the distance threshold q), the relative positional encoding in a LeakyAlibi relative positional encoding method is interpolated into a relative positional encoding value range before text length extrapolation, whereby a text length supported by the relative positional encoding is extended on the premise that a text processing effect of the text processing model is ensured.

S805: Invoke the text processing model, and perform semantic understanding on the source text according to the mapped positional encoding information, to generate a semantically associated text of the source text.

For ease of understanding, any token (any token may be represented as the i^{th} token) in the source text is used as an example herein, and a process in which a relative positional encoding of the i^{th} token participates in semantic understanding is described:

The mapped positional encoding information may include a target relative positional encoding between the i^{th} token and each preceding token. A first attention weight between the i^{th} token and each preceding token may be determined according to a similarity between the i^{th} token (specifically, an element value of the i^{th} token in a Q matrix) and each preceding token (specifically, an element value of the j^{th} preceding token in a K matrix). The first attention weight between the i^{th} token and each preceding token may be updated according to the target relative positional encoding between the i^{th} token and each preceding token, to obtain a second attention weight between the i^{th} token and each preceding token. Weighted summation is performed on each preceding token (specifically, an element value of the preceding token in a V matrix) according to the second attention weight between the i^{th} token and each preceding token, to obtain a semantic feature corresponding to the i^{th} token.

For example, as shown in FIG. 10, the source text includes 4 tokens, which are the 1^{st} token, the 2^{nd} token, the 3^{rd} token, and the 4^{th} token, respectively. The 3^{rd} token is used as an example herein, and a process of determining a semantic feature of the 3^{rd} token according to a relative positional encoding of the 3^{rd} token. First, a first attention weight q₃k₁ between the 3^{rd} token and the 1^{st} token may be determined according to a similarity between the 3^{rd} token and the 1^{st} token. By analogy, a first attention weight q₃k₂ between the 3^{rd} token and the 2^{nd} token and a first attention weight q₃k₃ between the 3^{rd} token and the 3^{rd} token may be obtained. Second, the first attention weight q₃k₁ between the 3^{rd} token and the 1^{st} token may be updated according to a target relative positional encoding LeakyAlibi (3,1, φ) between the 3^{rd} token and the 1^{st} token, to obtain a second attention weight q₃k′₁ between the 3^{rd} token and the 1^{st} token. By analogy, a second attention weight q₃k′₂ between the 3^{rd} token and the 2^{nd} token and a second attention weight q₃k′₃ between the 3^{rd} token and the 3^{rd} token may be obtained. Then, weighted summation q₃k′₁v₁+q₃k′₂v₂+q₃k₃₁₃ may be performed on the 1^{st} token, the 2^{nd} token, and the 3^{rd} token according to the obtained second attention weights, to obtain a semantic feature of the 3^{rd} token, where v₁ denotes an element value of the 1^{st} token in a V matrix, v₂ denotes an element value of the 2^{nd} token in a V matrix, and v₃ denotes an element value of the 3^{rd} token in the V matrix.

According to the foregoing method for determining the semantic feature of the i^{th} token, a semantic feature of another token than the i^{th} token in the source text may be determined. For a method for determining a semantic feature of another token, specifically refer to the method for determining the semantic feature of the i^{th} token. Details are not described herein again. After semantic features of tokens in the source text are determined, semantic understanding may be performed on the source text according to the semantic features of the tokens in the source text, to generate the semantically associated text of the source text.

Semantic understanding may specifically refer to recursive semantic understanding described in operation S504 in the foregoing embodiment shown in FIG. 5. Specifically, the text processing model may be invoked, and the 1^{st} semantic understanding is performed on the source text according to the mapped positional encoding information, to generate a semantically associated token corresponding to the 1^{st} semantic understanding. A text formed by the semantically associated token corresponding to the 1^{st} semantic understanding and the source text is used as a new source text, and the text processing model is invoked again to perform recursive semantic understanding until a recursion termination condition is satisfied. After the recursion termination condition is satisfied, a text formed by the semantically associated token corresponding to the 1^{st} semantic understanding and semantically associated tokens obtained through recursive semantic understanding is determined as the semantically associated text of the source text.

The text processing model is a pre-trained large language model, and the text processing model has a text processing capability (the text processing capability herein refers to a capability of performing semantic understanding on an input text, to generate a semantically associated text of the input text). Therefore, the text processing model may be directly used for inference. Being directly used for inference refers to directly using the text processing model to perform text processing. Alternatively, in a case that resources are sufficient to support secondary fine-tuning of the text processing model, the text processing model may be fine-tuned according to a task requirement of a text processing task.

For the foregoing two usage conditions (direct inference or second fine-tuning) of the text processing model, different distance thresholds φ may be set. Specifically, a method for obtaining the distance threshold may include any one of the following:

First method: in a case that the text processing model is directly used for inference, a maximum text length in text lengths of texts processed by the text processing model in a training process may be obtained; and the distance threshold is set according to the first text length. Specifically, the distance threshold is set according to the first text length, and the first text length is the maximum text length in the text lengths of the texts processed by the text processing model in the training process. For example, the first text length is l₁, and the distance threshold φ may be set to l₁/2. In this case, the distance threshold φ is set to l₁/2 according to an empirical value. In this way, when processing a long text, the text processing model can achieve good performance without requiring extensive fine-tuning, to achieve a good text processing effect.

Second method: in a case that second fine-tuning is performed on the text processing model, the distance threshold φ may be set as one learnable model parameter. Which is adjusted to an ideal value in a fine-tuning process of the text processing model. The ideal value allows the text processing model to achieve a good text processing effect when processing a long text. In addition, an initial value of the learnable model parameter may be set to l₁ and is restricted to an interval [0, l₁] in the fine-tuning process. To be specific, an initial threshold (the initial threshold refers to the initial value l₁) may be obtained, the initial threshold is used as a model parameter of the text processing model, and the model parameter is adjusted in the fine-tuning process of the text processing model, to obtain the distance threshold.

Specifically, the process of using the initial threshold as the model parameter of the text processing model, and adjusting the model parameter in the fine-tuning process of the text processing model, to obtain the distance threshold may include: first, a sample text set is obtained. The sample text set includes a plurality of sample texts, and a text length of each sample text is greater than the maximum text length (namely, the first text length) in the text lengths of the texts processed by the text processing model in the training process. In addition, if a text length is specified in the text processing task, the text length of each sample text in the sample text set may be the specified text length, which allows the fine-tuned text processing model and the distance threshold to better meet the task requirement of the text processing task. Second, iterative fine-tuning is performed on the text processing model according to the sample text set, to adjust the model parameter of the text processing model. When the model parameter of the text processing model is adjusted, the model parameter used as the distance threshold may be adjusted, and other model parameters are not adjusted. Alternatively, the model parameter used as the distance threshold and other model parameters may be adjusted together. Then, when an iterative fine-tuning termination condition is satisfied, a model parameter of the text processing model that is obtained when the iterative fine-tuning termination condition is satisfied is determined as the distance threshold.

Further, iterative fine-tuning refers to performing fine tuning on the text processing model for a plurality of times, and performing the next fine-tuning based on the previous fine-tuning. A sample text used in any fine-tuning process in the iterative fine-tuning process may be represented as a reference text, and the sample text set may further include a marked semantically associated text of the reference text. Any fine-tuning process in the iterative fine-tuning process may include: first, the reference text is obtained, the reference text including a plurality of sample tokens; and positional encoding information corresponding to the reference text is obtained, the positional encoding information corresponding to the reference text including a relative positional encoding between paired sample tokens in the reference text, and the relative positional encoding between the paired sample tokens being determined according to a relative distance between the paired sample tokens in the reference text. Second, the text processing model may be invoked, and a first relative positional encoding in the positional encoding information corresponding to the reference text is mapped into the positional encoding range of the text processing model, to obtain a target relative positional encoding corresponding to the first relative positional encoding. The first relative positional encoding is a relative positional encoding that is in the positional encoding information corresponding to the reference text and that corresponds to a relative distance exceeding the distance threshold. Then, the text processing model may be invoked, and semantic understanding is performed on the reference text according to mapped positional encoding information, to generate an actual semantically associated text of the reference text. Loss information of the text processing model may be determined according to a difference between the actual semantically associated text of the reference text and the marked semantically associated text of the reference text, and the model parameter of the text processing model may be adjusted according to the loss information of the text processing model.

Satisfying the iterative fine-tuning termination condition may include any one of the following: a quantity of times of fine tuning included in iterative fine-tuning reaches a quantity threshold of times, and the loss information of the text processing model is less than a loss threshold. In addition, the fine-tuning process of the text processing model is similar to an inference process of the text processing model. Operations in the fine-tuning process of the text processing model that are similar to those in the inference process of the text processing model are not described herein again. For details, refer to the inference process of the text processing model. The distance threshold is fine-tuned, and is adjusted to the ideal value in the fine-tuning process of the text processing model. The ideal value can allow the text processing model to achieve a good text processing effect when processing a long text, and moreover, can allow the text processing model to better meet the task requirement of the text processing task.

In the embodiments of the present disclosure, when the text length of the source text exceeds the text length processed by the text processing model in the training process, for the relative positional encoding between the paired tokens in the source text, the relative positional encoding may be mapped into the positional encoding range of the text processing model when the relative distance corresponding to the relative positional encoding is greater than the distance threshold, and text processing is performed on the source text based on the relative positional encoding within the positional encoding range. In this way, the text processing model can maintain a good text processing effect. The original relative positional encoding may remain unchanged when the relative distance corresponding to the relative positional encoding is less than or equal to the distance threshold, to avoid impact on attention weight distribution between adjacent tokens after mapping. That is, in the embodiments of the present disclosure, the text length processed by the text processing model may be extended while it is ensured that the text processing effect of the text processing model is not affected, whereby the text processing model can process a text with a text length exceeding a length of a training text. In addition, under different usage conditions (direct inference or second fine-tuning) of the text processing model, different distance thresholds are set. In a case that the text processing model is directly used for inference, the distance threshold is set according to the empirical value. In this way, when processing a long text, the text processing model can also achieve good performance without requiring extensive fine-tuning, to achieve a good text processing effect. In a case that second fine-tuning is performed on the text processing model, the distance threshold is adjusted as a learnable model parameter in a fine-tuning process of the text processing model. In this way, the adjusted distance threshold can allow the text processing model to achieve a good text processing effect when processing a long text.

The foregoing describes the method in the embodiments of the present disclosure in detail. To better implement the foregoing solutions in the embodiments of the present disclosure, correspondingly, the following provides an apparatus in the embodiments of the present disclosure.

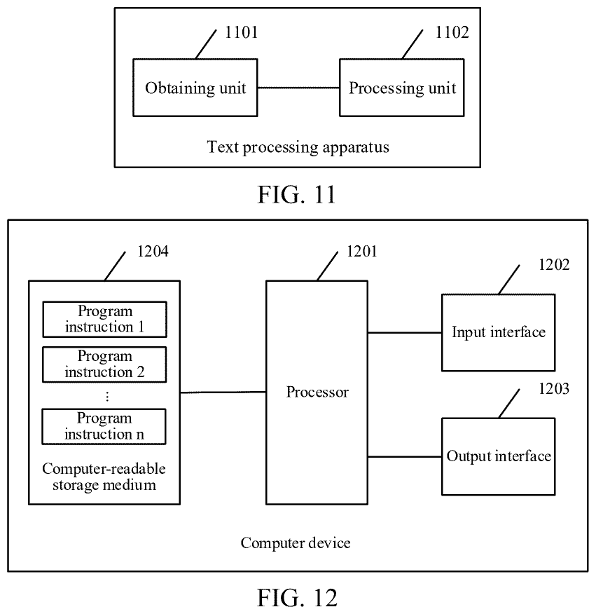

FIG. 11 is a schematic structural diagram of a text processing apparatus according to an embodiment of the present disclosure. The text processing apparatus may be disposed on a computer device provided in the embodiments of the present disclosure. The computer device may be a terminal device or a server. The text processing apparatus shown in FIG. 11 may be a computer program running on the computer device. The text processing apparatus may be configured to perform some or all of the operations in the method embodiment shown in FIG. 5 or FIG. 8. Refer to FIG. 11. The text processing apparatus includes the following units:
an obtaining unit 1101, configured to obtain a to-be-processed source text, the source text including a plurality of tokens,
the obtaining unit 1101 being further configured to determine, according to a relative distance between paired tokens in the source text, relative positional encoding corresponding to the relative distance between the paired tokens, to obtain positional encoding information including the relative positional encoding; and
a processing unit 1102, configured to obtain a distance threshold, and determine, from the positional encoding information, a first relative positional encoding corresponding to a relative distance that exceeds the distance threshold; and invoke a text processing model, and map the first relative positional encoding in the positional encoding information into a positional encoding range of the text processing model, to obtain mapped positional encoding information,
the processing unit 1102 being further configured to invoke the text processing model, and perform semantic understanding on the source text according to the mapped positional encoding information, to generate a semantically associated text of the source text.

In some embodiments, the processing unit 1102 is further configured to perform the following operations: determine, from the positional encoding information, a second relative positional encoding corresponding to a relative distance that does not exceed the distance threshold; and invoke the text processing model to determine the second relative positional encoding in the positional encoding information as a target relative positional encoding corresponding to the second relative positional encoding, the mapped positional encoding information including a target relative positional encoding obtained by mapping the first relative positional encoding and the target relative positional encoding corresponding to the second relative positional encoding.

In some embodiments, the source text includes N tokens, and the i^{th} token in the N tokens is arranged at the i^{th} position in the source text, where Nis an integer greater than 1, and i is an integer less than or equal to N. The positional encoding information includes a relative positional encoding between the i^{th} token and each preceding token of the i^{th} token. The preceding token is any token arranged from the 1^{st} position to the i^{th} position in the source text.

The processing unit 1102 is configured to invoke the text processing model, and map the first relative positional encoding in the relative positional encoding between the i^{th} token and each preceding token to the target relative positional encoding that is within the positional encoding range of the text processing model and that corresponds to the first relative positional encoding, to obtain the mapped positional encoding information.

In some embodiments, the processing unit 1102 is configured to invoke the text processing model, to determine the second relative positional encoding in the relative positional encoding between the i^{th} token and each preceding token as the target relative positional encoding corresponding to the second relative positional encoding.

In some embodiments, a relative distance between the i^{th} token and the j^{th} preceding token exceeds the distance threshold, where j is a positive integer less than or equal to i. The processing unit 1102 is configured to obtain an interpolation function, the interpolation function being generated according to a first text length, a second text length, and a distance threshold, the first text length referring to a maximum text length in text lengths of texts processed by the text processing model in a training process, the second text length referring to a text length of the source text, and the text length of the source text referring to a quantity of tokens included in the source text, and a value domain of the interpolation function being the positional encoding range of the text processing model; and perform interpolation on the first relative positional encoding between the i^{th} token and the j^{th} preceding token according to the interpolation function, to obtain the target relative positional encoding corresponding to the first relative positional encoding between the i^{th} token and the j^{th} preceding token.

In some embodiments, the mapped positional encoding information includes a target relative positional encoding between the i^{th} token and each preceding token. The processing unit 1102 is configured to determine a first attention weight between the i^{th} token and each preceding token according to a similarity between the i^{th} token and each preceding token; update the first attention weight between the i^{th} token and each preceding token according to the target relative positional encoding between the i^{th} token and each preceding token, to obtain a second attention weight between the i^{th} token and each preceding token; perform weighted summation on each preceding token according to the second attention weight between the i^{th} token and each preceding token, to obtain a semantic feature corresponding to the i^{th} token; and perform semantic understanding on the source text according to semantic features of tokens in the source text, to generate the semantically associated text of the source text.

In some embodiments, the processing unit 1102 is configured to obtain the maximum text length in the text lengths of the texts processed by the text processing model in the training process; and set the distance threshold according to the first text length.

In some embodiments, the processing unit 1102 is configured to obtain an initial threshold, use the initial threshold as a model parameter of the text processing model, and adjust the model parameter in a fine-tuning process of the text processing model, to obtain the distance threshold.

In some embodiments, the processing unit 1102 is configured to obtain a sample text set, the sample text set including a plurality of sample texts, and a text length of each sample text being greater than the maximum text length in the text lengths of the texts processed by the text processing model in the training process; perform iterative fine-tuning on the text processing model according to the sample text set, to adjust the model parameter of the text processing model; and determine, when an iterative fine-tuning termination condition is satisfied, a model parameter of the text processing model that is obtained when the iterative fine-tuning termination condition is satisfied as the distance threshold.

In some embodiments, the processing unit 1102 is configured to invoke the text processing model, and perform the 1^{st} semantic understanding on the source text according to the mapped positional encoding information, to generate a semantically associated token corresponding to the 1^{st} semantic understanding; use a text formed by the semantically associated token corresponding to the 1^{st} semantic understanding and the source text as a new source text, and continue to invoke the text processing model to perform recursive semantic understanding until a recursion termination condition is satisfied; and determine, after the recursion termination condition is satisfied, a semantically associated token corresponding to the 1^{st} semantic understanding and a text formed by semantically associated tokens obtained through recursive semantic understanding as the semantically associated text of the source text.

In some embodiments, satisfying the recursion termination condition includes any one of the following: a semantically associated token obtained through prediction is a specified token, or a quantity of semantically associated tokens obtained through prediction reaches a specified quantity.

In some embodiments, the obtaining unit 1101 is configured to obtain the relative distance between the paired tokens in the source text; and obtain a relative distance coefficient. The processing unit 1102 is configured to calculate the relative positional encoding between the paired tokens according to the relative distance coefficient and the relative distance between the paired tokens in the source text.

In some embodiments, the text processing model includes a plurality of attention fusion modules, and the relative positional encoding between the paired tokens in the source text is applied to the plurality of attention fusion modules. If each attention fusion module includes a plurality of attention fusions, coefficients corresponding to the attention fusions are different.

According to another embodiment of the present disclosure, the units of the text processing apparatus shown in FIG. 11 may be separately or wholly combined into one or a plurality of other units, or one (or more) of the units may further be divided into a plurality of units of smaller functions. In this way, same operations can be implemented, and implementation of the technical effects of the embodiments of the present disclosure is not affected. The units are divided based on logical functions. In practical application, a function of one unit may be implemented by a plurality of units, or functions of a plurality of units may be implemented by one unit. In other embodiments of the present disclosure, the text processing apparatus may further include another unit. In practical application, the functions may alternatively be cooperatively implemented by the another unit and may be cooperatively implemented by a plurality of units.

According to another embodiment of the present disclosure, a computer program that can perform some or all of the operations involved in the method shown in FIG. 5 or FIG. 8 may run on a general-purpose computing device including processing components and storage components such as a central processing unit (CPU), a random-access memory (RAM), and a read-only memory (ROM), such as a computer, to construct the text processing apparatus shown in FIG. 11 and implement the text processing method in the embodiments of the present disclosure. The computer program may be stored in, for example, a computer-readable storage medium, is installed in the computing device through the computer-readable storage medium, and is run on the computing device.

In the embodiments of the present disclosure, when the text length of the source text exceeds a text length appearing in the training process of the text processing model, a positional encoding range within which the relative positional encoding between the paired tokens in the source text falls exceeds the positional encoding range of the text processing model. Consequently, a text processing effect of the text processing model is poor. In this case, in the embodiments of the present disclosure, the relative positional encoding corresponding to the relative distance that exceeds the distance threshold is mapped into the positional encoding range of the text processing model. In this way, the text processing model can achieve a good text processing effect when performing text processing on the source text based on the mapped relative positional encoding. That is, in the embodiments of the present disclosure, when text processing is performed on the source text with the text length exceeding a training text length (namely, the seen text length in the training process of the text processing model), the relative positional encoding between the paired tokens in the source text is mapped into the positional encoding range of the text processing model. In this way, the text processing model can achieve a good text processing effect on the source text with the text length exceeding the training text length, whereby generalization performance of the text processing model can be improved.

Based on the foregoing method and apparatus embodiments, the embodiments of the present disclosure provide a computer device. FIG. 12 is a schematic structural diagram of a computer device according to an embodiment of the present disclosure. The computer device shown in FIG. 12 includes at least a processor 1201, an input interface 1202, an output interface 1203, and a computer-readable storage medium 1204. The processor 1201, the input interface 1202, the output interface 1203, and the computer-readable storage medium 1204 may be connected through a bus or in another manner.

The computer-readable storage medium 1204 may be stored in a memory of the computer device. The computer-readable storage medium 1204 is configured to store a computer program. The computer program includes computer instructions. The processor 1201 is configured to execute the computer program stored in the computer-readable storage medium 1204. The processor 1201 (or referred to as a CPU) is a computing core and a control core of the computer device, is configured to implement the computer program, and is specifically configured to load and execute the computer program to implement a corresponding method process or a corresponding function.

The embodiments of the present disclosure further provide a computer-readable storage medium (memory). The computer-readable storage medium is a storage device in a computer device, and is configured to store a program and data. The computer-readable storage medium herein may include an internal storage medium of the computer device, and may further include an expanded storage medium supported by the computer device. The computer-readable storage medium provides storage space, and an operating system of the computer device is stored in the storage space. In addition, a computer program loaded and executed by a processor is further stored in the storage space. The computer-readable storage medium herein may be a high-speed RAM, or may be a non-volatile memory, for example, at least one magnetic disk memory. In an embodiment, the computer-readable storage medium may alternatively be at least one computer-readable storage medium located far away from the foregoing processor.

The computer device may be a terminal device or a server. In a specific implementation, the processor 1201 may load and execute the computer program stored in the computer-readable storage medium 1204, to implement corresponding operations in the foregoing text processing method shown in FIG. 5 or FIG. 8. In a specific implementation, the computer program in the computer-readable storage medium 1204 is loaded by the processor 1201 to perform the following operations: obtaining a to-be-processed source text, the source text including a plurality of tokens; determining, according to a relative distance between paired tokens in the source text, a relative positional encoding corresponding to the relative distance between the paired tokens, to obtain positional encoding information including the relative positional encoding; obtaining a distance threshold, and determining, from the positional encoding information, a first relative positional encoding corresponding to a relative distance that exceeds the distance threshold; invoking a text processing model, and mapping the first relative positional encoding in the positional encoding information into a positional encoding range of the text processing model, to obtain mapped positional encoding information; and invoking the text processing model, and performing semantic understanding on the source text according to the mapped positional encoding information, to generate a semantically associated text of the source text.

In the embodiments of the present disclosure, when a text length of the source text exceeds a seen text length in a training process of the text processing model, a positional encoding range within which the relative positional encoding between the paired tokens in the source text falls exceeds the positional encoding range of the text processing model. Consequently, a text processing effect of the text processing model is poor. In this case, in the embodiments of the present disclosure, the relative positional encoding corresponding to the relative distance that exceeds the distance threshold is mapped into the positional encoding range of the text processing model. In this way, the text processing model can achieve a good text processing effect when performing text processing on the source text based on the mapped relative positional encoding. That is, in the embodiments of the present disclosure, when text processing is performed on the source text with the text length exceeding a training text length (namely, the seen text length in the training process of the text processing model), the relative positional encoding between the paired tokens in the source text is mapped into the positional encoding range of the text processing model. In this way, the text processing model can achieve a good text processing effect on the source text with the text length exceeding the training text length, whereby generalization performance of the text processing model can be improved.

The embodiments of the present disclosure further provide a computer program product or a computer program. The computer program product or the computer program includes computer instructions, and the computer instructions are stored in a computer-readable storage medium. A processor of a computer device reads the computer instructions from the computer-readable storage medium and executes the computer instructions, to cause the computer device to perform the foregoing text processing method.

A person of ordinary skill in the art may be aware that the exemplary units and algorithm operations described with reference to the embodiments disclosed in the present disclosure can be implemented by electronic hardware, or a combination of computer software and electronic hardware. Whether the functions are executed in a form of hardware or software depends on particular application and design constraint conditions of the technical solutions. A person skilled in the art may use different methods to implement the described functions for each particular application, but such implementation is not to be considered beyond the scope of the present disclosure.

In the embodiments of the present disclosure, the term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The foregoing embodiments may be partially or completely implemented through software, hardware, firmware, or any combination thereof. The foregoing embodiments, when implemented by using software, may be partially or completely implemented in a form of a computer program product. The computer program product includes one or more computer instructions. When the computer instructions are loaded and executed on a computer, all or some processes or functions according to the embodiments of the present disclosure are generated. The computer may be a general-purpose computer, a special-purpose computer, a computer network, or another programmable device. The computer instructions may be stored in a computer-readable storage medium, or transmitted through the computer-readable storage medium. The computer instructions may be transmitted from a website, computer, server, or data center to another website, computer, server, or data center by using a wired (such as a coaxial cable, an optical fiber, or a digital subscriber line (DSL)) or wireless (such as infrared, radio, or microwave) protocol. The computer-readable storage medium may be any available medium that can be accessed by the computer, or may be a data storage device, such as a server or a data center in which one or more available media are integrated. The available medium may be a magnetic medium (such as a floppy disk, a hard disk, or a magnetic tape), an optical medium (such as a digital video disc (DVD)), a semiconductor medium (such as a solid state disk (SSD)), or the like.

Technical features of the foregoing embodiments may be combined in different ways to form new embodiments. For concision of description, not all possible combinations of the technical features in the foregoing embodiments are described. However, all the combinations of these technical features are considered as falling within the scope recorded by this specification provided that no conflict exists.

The foregoing embodiments only describe several implementations of the present disclosure, which are described specifically and in detail, but cannot be construed as a limitation on the patent scope of the present disclosure. For a person of ordinary skill in the art, several transformations and improvements can be made without departing from the concept of the present disclosure. These transformations and improvements still fall within the protection scope of the present disclosure. Therefore, the protection scope of the patent of the present disclosure is subject to the appended claims.

What is claimed is:

1. A text processing method, performed by a computer device, comprising:
obtaining a to-be-processed source text, the source text comprising a plurality of tokens;
obtaining positional encoding information by determining, according to a relative distance between each token pair of a plurality of token pairs in the source text, a relative positional encoding corresponding to the relative distance between each token pair, wherein the positional encoding information comprises relative positional encodings for the plurality of token pairs;
obtaining a distance threshold, and determining, based on the positional encoding information, a first relative positional encoding corresponding to a relative distance exceeding the distance threshold;
obtaining mapped positional encoding information by invoking a text processing model and mapping the first relative positional encoding among the relative position encodings in the positional encoding information into a positional encoding range of the text processing model; and
generating a semantically associated text of the source text by invoking the text processing model and performing semantic understanding on the source text according to the mapped positional encoding information.

2. The method according to claim 1, wherein the mapped positional encoding information comprises a target relative positional encoding obtained by mapping the first relative positional encoding and a target relative positional encoding corresponding to a second relative positional encoding.

3. The method according to claim 2, wherein the target relative positional encoding corresponding to the second relative positional encoding is obtained by:
determining, based on the positional encoding information, the second relative positional encoding corresponding to a relative distance not exceeding the distance threshold; and
invoking the text processing model, and determining the second relative positional encoding in the positional encoding information as the target relative positional encoding corresponding to the second relative positional encoding.

4. The method according to claim 3, wherein the source text comprises N tokens, wherein an i^{th} token in the N tokens is arranged at an i^{th} position in the source text, Nis an integer greater than 1, and i is an integer less than or equal to N;
wherein the positional encoding information comprises a relative positional encoding between the i^{th} token and each preceding token of the i^{th} token, each preceding token being any token arranged from a 1^{st} position to an i^{th} position in the source text; and
wherein obtaining mapped positional encoding information by invoking the text processing model and mapping the first relative positional encoding in the positional encoding information into the positional encoding range of the text processing model comprises:
invoking the text processing model, and mapping a first relative positional encoding in the relative positional encoding between the i^{th} token and each preceding token to a target relative positional encoding that is within the positional encoding range of the text processing model and that corresponds to the first relative positional encoding; and
obtaining the mapped positional encoding information.

5. The method according to claim 4, wherein invoking the text processing model, and determining the second relative positional encoding in the positional encoding information as the target relative positional encoding corresponding to the second relative positional encoding comprises:
invoking the text processing model, and determining a second relative positional encoding in the relative positional encoding between the i^{th} token and each preceding token as a target relative positional encoding corresponding to the second relative positional encoding.

6. The method according to claim 5, wherein a relative distance between the i^{th} token and a j^{th} preceding token exceeds the distance threshold, j being a positive integer less than or equal to i; and
wherein the method further comprises:
obtaining an interpolation function, the interpolation function being generated according to a first text length, a second text length, and the distance threshold,
the first text length referring to a maximum text length in text lengths of texts processed by the text processing model in a training process,
the second text length referring to a text length of the source text,
the text length of the source text referring to a quantity of tokens comprised in the source text, and
a value range of the interpolation function being the positional encoding range of the text processing model; and
wherein mapping the first relative positional encoding in the relative positional encoding between the i^{th} token and each preceding token to the target relative positional encoding that is within the positional encoding range of the text processing model and that corresponds to the first relative positional encoding comprises:
performing interpolation on a first relative positional encoding between the i^{th} token and the j^{th} preceding token according to the interpolation function, to obtain the target relative positional encoding corresponding to the first relative positional encoding between the i^{th} token and the j^{th} preceding token.

7. The method according to claim 6, wherein the mapped positional encoding information comprises a target relative positional encoding between the i^{th} token and each preceding token; and
wherein generating the semantically associated text of the source text by invoking the text processing model and performing semantic understanding on the source text according to the mapped positional encoding information comprises:
determining a first attention weight between the i^{th} token and each preceding token according to a similarity between the i^{th} token and each preceding token;
updating the first attention weight between the i^{th} token and each preceding token according to the target relative positional encoding between the i^{th} token and each preceding token, to obtain a second attention weight between the i^{th} token and each preceding token;
performing weighted summation on each preceding token according to the second attention weight between the i^{th} token and each preceding token, to obtain a semantic feature corresponding to the i^{th} token; and
performing semantic understanding on the source text according to semantic features of the tokens in the source text, to generate the semantically associated text of the source text.

8. The method according to claim 6, further comprising:
obtaining the maximum text length in the text lengths of the texts processed by the text processing model in the training process; and
setting a distance threshold according to the first text length.

9. The method according to claim 6, further comprising:
obtaining an initial threshold, using the initial threshold as a model parameter of the text processing model, and adjusting the model parameter in a fine-tuning process of the text processing model, to obtain the distance threshold.

10. The method according to claim 9, wherein using the initial threshold as the model parameter of the text processing model, and adjusting the model parameter in the fine-tuning process of the text processing model, to obtain the distance threshold comprises:
obtaining a sample text set, the sample text set comprising a plurality of sample texts, and a text length of each sample text being greater than the maximum text length in the text lengths of the texts processed by the text processing model in the training process;
performing iterative fine-tuning on the text processing model according to the sample text set, to adjust the model parameter of the text processing model; and
determining, when an iterative fine-tuning termination condition is satisfied, a model parameter of the text processing model that is obtained when the iterative fine-tuning termination condition is satisfied as the distance threshold.

11. The method according to claim 1, wherein generating the semantically associated text of the source text by invoking the text processing model and performing semantic understanding on the source text according to the mapped positional encoding information comprises:
invoking the text processing model, and performing a 1^{st} semantic understanding on the source text according to the mapped positional encoding information, to generate a semantically associated token corresponding to the 1^{st} semantic understanding;
using a text formed by the semantically associated token corresponding to the 1^{st} semantic understanding and the source text as a new source text, and continuing to invoke the text processing model to perform recursive semantic understanding until a recursion termination condition is satisfied; and
determining, after the recursion termination condition is satisfied, a text formed by the semantically associated token corresponding to the 1^{st} semantic understanding and semantically associated tokens obtained through recursive semantic understanding as the semantically associated text of the source text.

12. The method according to claim 11, wherein satisfying the recursion termination condition comprises any one of the following:
a semantically associated token obtained through prediction is a specified token, or a quantity of semantically associated tokens obtained through prediction reaches a specified quantity.

13. The method according to claim 1, wherein determining, according to the relative distance between each token pair of the plurality of token pairs in the source text, the relative positional encoding corresponding to the relative distance between each token pair, wherein the positional encoding information comprises relative positional encodings for the plurality of token pairs, comprises:
obtaining the relative distance between each token pair of the plurality of token pairs in the source text; and
obtaining a relative distance coefficient, and calculating the relative positional encoding corresponding to the relative distance between each token pair according to the relative distance coefficient and the relative distance between each token pair of the plurality of token pairs in the source text.

14. The method according to claim 1, wherein the text processing model comprises a plurality of attention fusion modules, and the relative positional encoding corresponding to the relative distance between each token pair in the source text is applied to the plurality of attention fusion modules; and when each attention fusion module among the plurality of attention fusion modules comprises a plurality of attention fusions, coefficients corresponding to the plurality of attention fusions are different.

15. A text processing apparatus, comprising a memory for storing instructions and a processor for executing the instructions to:
obtain a to-be-processed source text, the source text comprising a plurality of tokens;
obtain positional encoding information by determining, according to a relative distance between each token pair of a plurality of token pairs in the source text, a relative positional encoding corresponding to the relative distance between each token pair, wherein the positional encoding information comprises relative positional encodings for the plurality of token pairs;
obtain a distance threshold, and determining, based on the positional encoding information, a first relative positional encoding corresponding to a relative distance exceeding the distance threshold;
obtain mapped positional encoding information by invoking a text processing model and mapping the first relative positional encoding among the relative position encodings in the positional encoding information into a positional encoding range of the text processing model; and
generate a semantically associated text of the source text by invoking the text processing model and performing semantic understanding on the source text according to the mapped positional encoding information.

16. The text processing apparatus according to claim 15, wherein the mapped positional encoding information comprises a target relative positional encoding obtained by mapping the first relative positional encoding and a target relative positional encoding corresponding to a second relative positional encoding.

17. The text processing apparatus according to claim 16, wherein the processor, when being configured to obtain the target relative positional encoding corresponding to the second relative positional encoding, is configured to execute the instructions to:
determine, based on the positional encoding information, the second relative positional encoding corresponding to a relative distance not exceeding the distance threshold; and
invoke the text processing model, and determine the second relative positional encoding in the positional encoding information as the target relative positional encoding corresponding to the second relative positional encoding.

18. The text processing apparatus according to claim 15, wherein the processor, when being configured to determine, according to the relative distance between each token pair of the plurality of token pairs in the source text, the relative positional encoding corresponding to the relative distance between each token pair, wherein the positional encoding information comprises relative positional encodings for the plurality of token pairs, is configured to execute the instructions to:
obtain the relative distance between each token pair of the plurality of token pairs in the source text; and
obtain a relative distance coefficient, and calculate the relative positional encoding corresponding to the relative distance between each token pair according to the relative distance coefficient and the relative distance between each token pair of the plurality of token pairs in the source text.

19. The text processing apparatus according to claim 15, wherein the text processing model comprises a plurality of attention fusion modules, and the relative positional encoding corresponding to the relative distance between each token pair in the source text is applied to the plurality of attention fusion modules; and when each attention fusion module among the plurality of attention fusion modules comprises a plurality of attention fusions, coefficients corresponding to the plurality of attention fusions are different.

20. A non-transitory computer readable medium storing a plurality of instructions, wherein the plurality of instructions, when executed by a processor, configure the instructions to:
obtain a to-be-processed source text, the source text comprising a plurality of tokens;
obtain positional encoding information by determining, according to a relative distance between each token pair of a plurality of token pairs in the source text, a relative positional encoding corresponding to the relative distance between each token pair, wherein the positional encoding information comprises relative positional encodings for the plurality of token pairs;
obtain a distance threshold, and determining, based on the positional encoding information, a first relative positional encoding corresponding to a relative distance exceeding the distance threshold;
obtain mapped positional encoding information by invoking a text processing model and mapping the first relative positional encoding among the relative position encodings in the positional encoding information into a positional encoding range of the text processing model; and
generate a semantically associated text of the source text by invoking the text processing model and performing semantic understanding on the source text according to the mapped positional encoding information.
